(19) United States
(12) Patent Application Publication
(10) Pub. No.: US 2005/0175315 A1
(43) Pub. Date: Aug. 11, 2005

(54) Electronic entertainment device

(76) Inventor: Glenn Ewing, Margate, FL (US)

Correspondence Address: Robert M. Downey;ROBERT M. DOWNEY, P.A., Suite 300, 601 South Federal Highway, Boca Raton, FL, 33432, US

(21) Appl. No.: 10/774,831

(22) Filed: Feb. 9, 2004

(51) Int. Cl. H04N 5/76; G11B 27/00

(52) U.S. Cl. 386/46; 386/54; 386/96

(57) ABSTRACT

An entertainment device receives broadcast or recorded audio signals from an original source and secondary audio signals from a secondary audio source such as one or more microphones or music from a connected auxiliary component. Controls on the entertainment device allow the volume levels of the original audio signals and the secondary audio signals to be selectively adjusted. The original audio signals and secondary audio signals are mixed at the adjusted volume levels and output for recording onto a recording medium, such as a VHS tape, CD, DVD or cassette tape. The mixed original audio signals and secondary audio signals may be combined with video signals from the original source for recording and/or output to a T.V. monitor and speakers. The device can be used for playing a game, for amusement and entertainment, wherein each player may assume a character role and interject dialogue or add sound effects.

### BACKGROUND OF THE INVENTION

1. Field of the Invention

An entertainment device for editing an original audio source and, more particularly, a device for mixing audio signals from an original source with secondary audio signals, such as voices or music, and outputting the mixed audio signals for live play and/or recording. The mixed audio signals may be combined with video signals from the orignal source for output to a T.V. monitor and speakers.

2. Discussion of the Related Art

Most people, at one time or another, have found themselves talking to the television. For instance, when watching certain movies, commercials or regular television programming with a group of friends or family members, it is sometimes amusing to mimic the characters or interject additional dialog, noises and comments. When viewing televised sporting events, such as football, basketball or baseball, many fans cannot resist adding their own commentary and opinions, especially after a controversial ruling by the officials or umpires. The spontaneous comments that people make when watching T.V. are sometimes extremely funny and may add to the overall entertainment of watching the program. The viewers may find some impulsive utterances to be so amusing that they replay the original program and attempt to duplicate the humorous expressions. However, the loss of spontaneity makes it difficult to recreate the same level of amusement as was first experienced. And, even though the original program may be recorded by the viewers, the spontaneous dialog, noises and other utterances are lost.

In other circumstances, a person may wish to repeat the lines of a character in a movie in order to hone their acting skills, such as when rehearsing for a character role. Someone interesting in sports broadcasting may wish to turn down the sound of a televised sporting event or other program and practice their commentary or narrating skills. Unfortunately, the user's verbal interjections cannot be recorded with the video portion of the original program.

Accordingly, there is a need for an electronic device or system which enables one or more people to listen to and/or view an original program while interjecting their own spontaneous utterances, and to produce a recorded product which consists of the original program combined with the user's dialog, noises or other expressions for the purpose of amusement and entertainment.

### OBJECTS AND ADVANTAGES OF THE INVENTION

With the foregoing in mind, it is a primary object of the present invention to provide a device or system which allows one or more users to alter the original audio portion of a broadcast or recorded program by mixing the user's selected audio with the original audio or by dubbing over the original audio.

It is a further object of the present invention to provide an electronic device or system which receives broadcast or recorded audio signals from an original source and secondary audio signals from a secondary audio source, as selected by the user(s), and wherein the device further includes volume control means for controlling the volume levels of the original audio signals and the secondary audio signals, wherein the original and secondary audio signals are mixed at the adjusted volume levels and recorded onto a selected medium, such as a VHS tape, CD, DVD or cassette tape.

It is still a further object of the present invention to provide an electronic device or system which can be used by one or more persons for amusement and entertainment purposes, as a type of game, wherein each person is provided with a microphone to allow spontaneous interjection of dialog, noises or other utterances while watching a broadcast or recorded video program on television, and wherein the utterances of each of the persons are mixed with or dubbed over the original audio track of the program and recorded onto a selected medium for subsequent playback and amusement.

It is still a further object of the present invention to provide an electronic entertainment device which allows one or more users to mix their own selected audio, such as voice dialog, noises, music or the like, with original audio of an original television broadcast program or recorded video program, and wherein the mixed audio and original video is recorded onto a selected medium for subsequent playback.

It is still a further object of the present invention to provide an electronic device or system which allows one or more persons to record over the original audio track of a broadcast or recorded program for entertainment, rehearsal, job application in the field of broadcasting or other purposes.

It is still a further object of the present invention to provide an entertainment device which provides for means of playing an original recorded video/audio program on a recorded medium and a second means for recording the original video portion of the original program with a modified audio track which may be a combination of the original audio with the user's selected audio or, alternatively, new audio, selected by the user, which is dubbed over the original audio track.

It is yet a further object of the present invention to provide any electronic device or system which receives broadcast and/or recorded video and audio signals from an original source and which further connects to microphones, an AM/FM radio tuner, a cassette tape player, a CD player, a DVD player and a VCR, and wherein the device is adapted to receive audio signals from anyone or a combination of the connected components for mixing with or dubbing over the audio of the original source, and further wherein the device is adapted to record the mixed audio with the video of the original source on a selected medium such as, but not limited to a VHS tape, CD or DVD.

It is still a further object of the present invention to provide an entertainment device or system which receives broadcast or recorded audio signals from an original source and secondary audio signals from one or more connected components such as an AM/FM radio tuner, a cassette tape player, a CD player, a DVD player or a VCR, and wherein the device or system is structured to selectively mix audio from the connected components with the audio from the original source, and further wherein the device or system is adapted to record the mixed audio on an audio storage medium or combined with the video of the original source on a video storage medium.

It is still a further object of the present invention to provide an entertainment device or system, as set forth above, which is adapted to connect with a camcorder or other personal video recording device for editing the audio on an originally recorded video storage medium, and more particularly for mixing dialogue, music and/or other noises with the audio on the originally recorded video storage medium. These and other objects and advantages of the present invention are more readily apparent with reference to the following detail description taken in conjunction with the accompanying drawings.

### SUMMARY OF THE INVENTION

The present invention is directed to an entertainment device for combining the audio of an original program with audio selected by the user(s), such as spontaneous utterances, dialogue, noises, music or the like. The entertainment device receives broadcast or recorded audio signals from the original source and secondary audio signals from a secondary audio source such as from one or more microphones or from a connected auxiliary component. Controls on the device allow the volume levels of the original audio signals and any of the secondary audio signals to be selectively adjusted. The original audio signals and the secondary audio signals are mixed at the adjusted volume levels and output for recording onto a recording medium, such as a VHS tape, CD, DVD or cassette tape. The mixed original audio signals and secondary audio signals may be combined with video signals from the original source for recording and/or output to a T.V. monitor and speakers. The device can be used for playing a game, for amusement and entertainment, wherein each player may assume a character role and interject dialogue or add sound effects.

### BRIEF DESCRIPTION OF THE DRAWINGS

For a fuller understanding of the nature of the present invention, reference should be made to the following detailed description taken in conjunction with the accompanying drawings in which:

FIG. 1 is a general schematic view of the electronic entertainment system of the present invention, in accordance with one preferred embodiment thereof;

FIG. 2 is a front elevational view showing the device of the present invention in accordance with one preferred embodiment thereof, and illustrating various controls and inputs thereon;

FIG. 3 is a rear elevational view of the device of FIG. 2 showing various input and output jacks thereon; and

FIG. 4 is a general schematic showing the electronic entertainment system in accordance with a second preferred embodiment thereof.

Like reference numerals refer to like parts throughout the several views of the drawings.

### DETAILED DESCRIPTION OF THE PREFERRED EMBODIMENTS

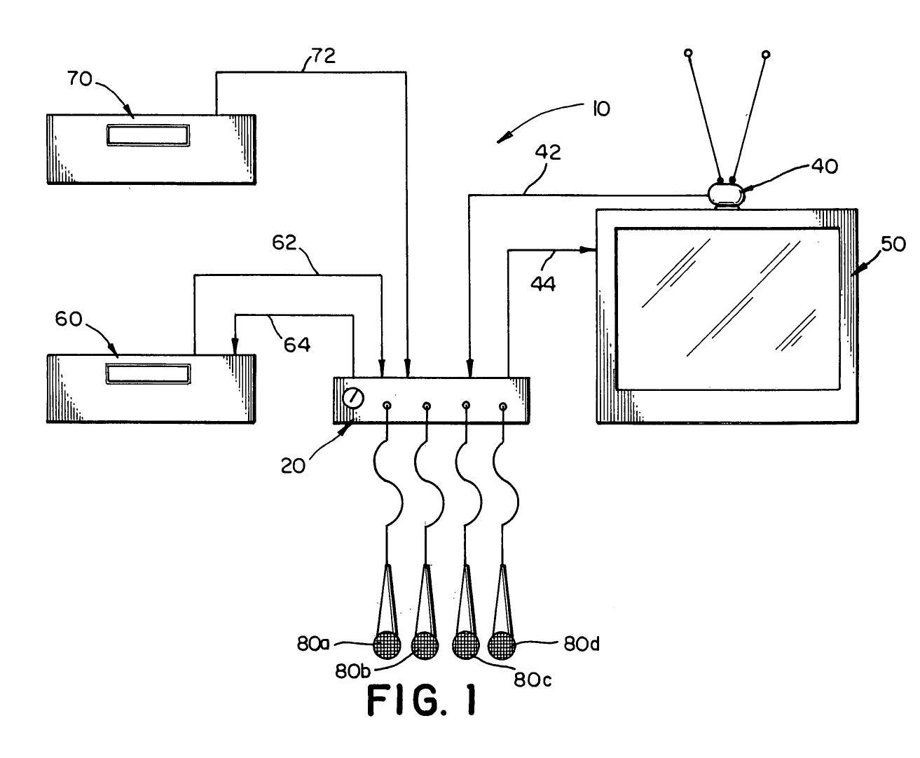

Referring to the several drawings, and initially FIGS. 1-3, a video and audio entertainment system is shown and generally indicated as 10.

As seen in FIG. 1, the system 10 includes a audio mixing device 20 which connects to the other components of the system. In a preferred embodiment, as shown in FIG. 1, the system 10 is used in conjunction with a television 50 when watching either a real time broadcast program via signals received through an antenna, cable or satellite receiver, or from a recorded medium played on a connected component 70. The broadcast signal, from the antenna/cable/satellite receiver 40 is directed through input cable 42 which connects to the In jack 46 on the rear of the device 20. This signal, which is input into the device 20, includes both original audio and original video from the broadcast program. When the power button on the device 20 is off, the video and audio signals from the broadcast signals pass through device 20 and are output through cable 44 connected to jack 48 and into the television 50 for real time normal play of the broadcast program. With the device 20 turned “ON,” by depressing power button a volume control knob 26 on the device 20 controls the volume level of the audio exiting output 48 to the television 50. With the knob 26 turned all the way to the left, the full volume level of the audio signal is output to the television 50 as normal. Turning the knob 26 fully to the right position results in completely muting the audio signal portion so that only the original video is displayed on the television 50. Moving the volume control knob 26 between the full left position and full right position controls the volume level of the original audio signal from the broadcast program between normal and mute prior to output to the television 50 and/or speakers.

The component 70 may be any of a select one or more audio and/or video components such as, but not limited to, a VCR, DVD player, CD player, AM/FM tuner or cassette tape player. The audio signals from the one or more components 70 are fed through input cable 72 and through input jack 74 on the rear of the mixer device 20.

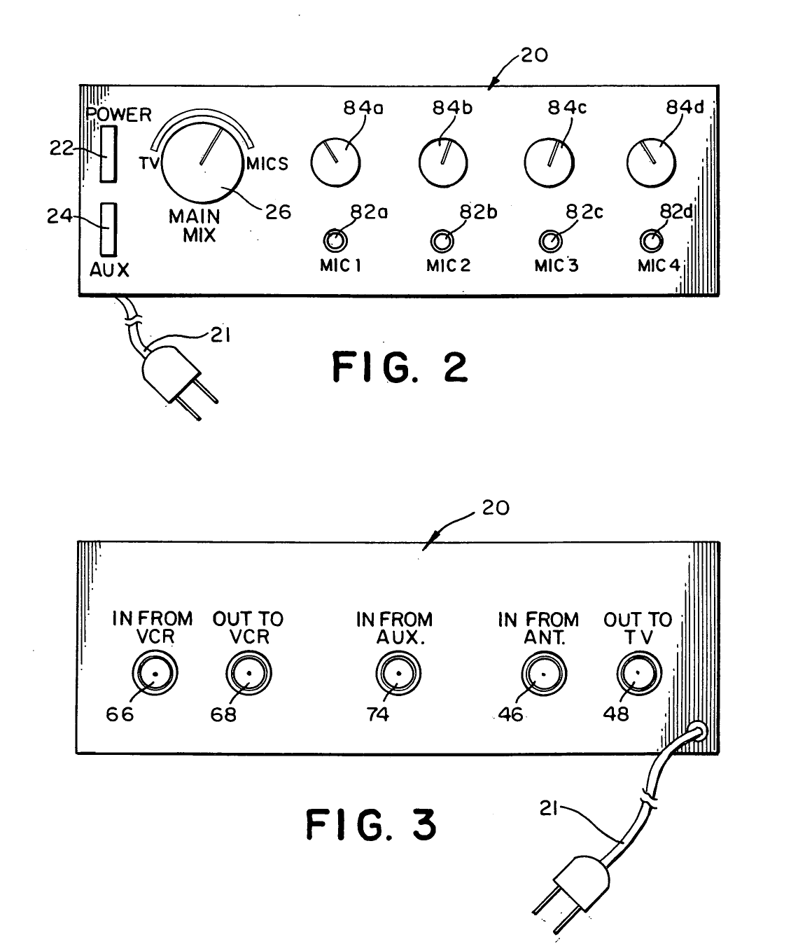

One or more microphones 80a-80d connect to the mixer device 20 by plugging into the corresponding jacks 82a-82d on the front of the device 20. Using the microphones 80a-80d, one or more users can interject additional dialogue, utterances, noises or other expressions, while watching and listening to the video program on the television 50. The volume level of each microphone is controlled by the corresponding knobs 84a-84d, as seen in FIG. 2. These secondary audio signals, received through the microphones 80a-80d, are mixed with the original audio signals of the broadcast program (i.e. from antenna, cable or satellite) or the recorded program from component 70. The mixed audio signals are output from device 20, at the adjusted levels, from output jack 48, through connecting cable 44 and to the audio system of the television 50. Thus, turning the volume control knob 26 all the way to the left will result in only the original audio portion of the program being heard, while turning the knob on the volume control 26 all the way to the right will result in only the secondary audio, input through microphones or other connected source, being heard on the T.V. while watching the video program. Adjusting the control knob 26 between the fully left and fully right positions results in a mixture of both the original audio and the secondary audio, so that both the original audio and the user's input dialogue, noises, utterances, music, etc. are heard while watching the program on the television 50.

A recording component 60 connects to the device 20 for recording the video program with the selectively adjusted mixed audio comprising either one or a mixture of both the original audio portion and the secondary audio interjected by the one or more users. The recording device 60 connects through input cable 62 to input jack 66 on the rear of the device. The original video from the broadcast program received through antenna/cable/satellite 40, or from the recorded original program played on component 70, is output from jack 68 through output cable 64 to the recording component 60. Likewise, the resultant mixed audio, comprising the original audio and/or the secondary audio, is output from jack 68 through cable 64 and to input of recording component 60. The original video and mixed audio are recorded onto a recording medium (e.g. a VHS tape, or DVD) in the recording device 60. Alternatively, the recording device 60 may be of the type adapted for recording only the audio portion, such as a CD player or cassette tape player. In this instance, only the mixed audio is output from device 20 and into the recording component 60 for recording on the particular audio recording medium (e.g. CD or cassette tape).

With the use of the second video/audio playing component 70, an original recorded audio/video program (both audio signals and video signals) can be input to mixing device 20 and mixed with the dialogue, noises, utterances, music and other expressions input by the users through microphones 80a-80d or another connected component (e.g. AM/FM tuner, CD player, tape player, etc.), and recorded onto a select medium in recording device 60. By pushing the auxiliary button 24 on the front of the machine, the audio signal or combined audio/video signal from component 70 is input into device 20 and mixed with the secondary audio signals from microphones 80a-80d or other components, and then rerouted to recording component 60 for recording onto the selected medium. The user's modified recorded version of the program, including he original audio and/or the user's selected audio, can then be played back on television 50 for amusement and entertainment.

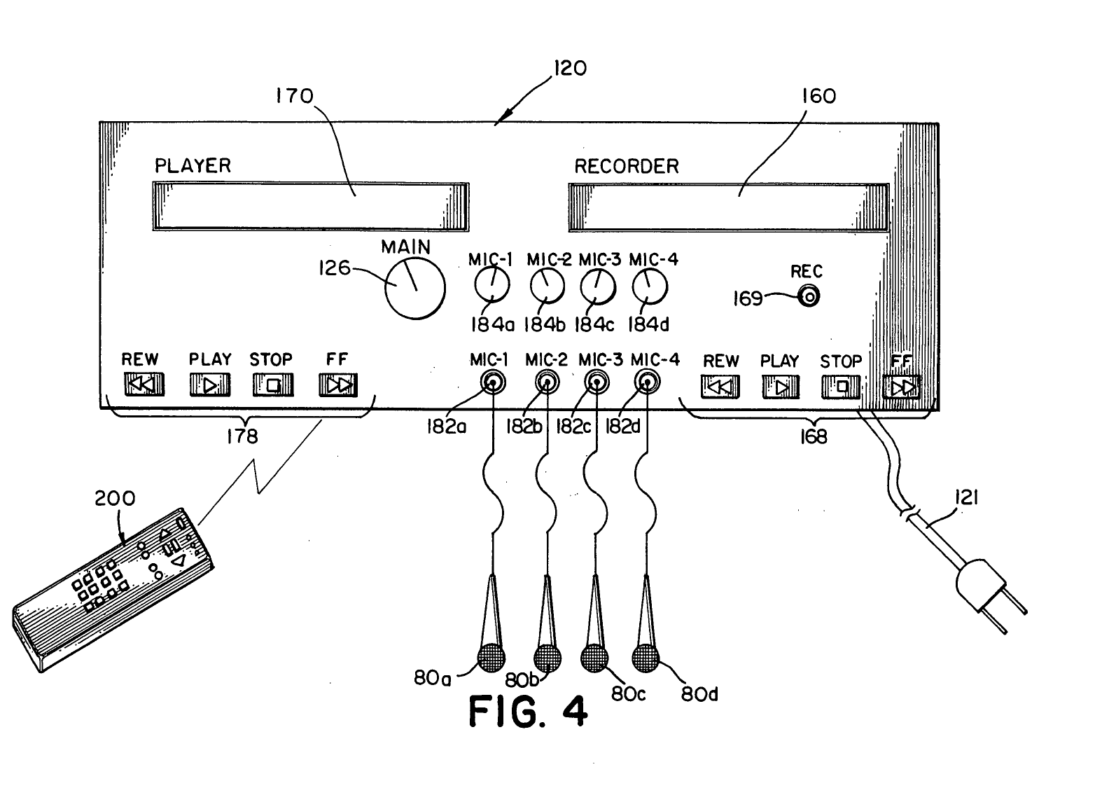

Referring to FIG. 4, another preferred embodiment of the device of the present invention as shown and as indicated as 120. In this particular embodiment, several components are combined into the one device 120, including an audio mixer, an audio or audio/video player 170 and an audio or audio/video player and recorder 160. Similar to the system 10 of FIG. 1, the device 120 connects to a television and is adapted to receive a broadcast signal via antenna, cable or satellite. The device 120 may further include multiple audio and/or audio/video player devices such as a VCR, DVD player, CD player, cassette tape player and an AM/FM tuner. It is fully contemplated that all of these audio and/or audio/video components may be incorporated within the device 124 for producing desired secondary audio signals to be mixed with or dubbed over an original audio signal. The recorder component 160 may be any one or more of various recording devices adapted for recording onto a medium, such as a cassette tape recorder, DVD recorder, CD recorder or VCR.

Similar to the system 10 of FIG. 1, the device 120, as shown in FIG. 4, allows for input of original video and audio signals from either a broadcast program (e.g. antenna, cable or satellite) or from a recorded medium played in the player component 170. The volume level of the original audio is controlled with main volume control knob 126. The secondary audio, to be mixed with the original audio, or dubbed over the original audio, may come from any one or more of the additional player components 170 or from an auxiliary device connected to the device 120, or from microphones 80a-80d similar to that described in connection with FIG. 1. The microphones 80a-80d plug into jacks 182a-182d on the front of the device 120 and the volume level of each of the microphones is controlled by knobs 184a-184d. Controls 178 are provided for a controlling operation of the player component 170. Additional player components may require additional controls, as appropriate.

In operation, the original audio, either from a broadcast signal or from a recorded medium played in player component 170, is mixed with the secondary audio derived from the one or more microphones 80a-80d and/or one or more other audio components (e.g. AM/FM tuner, CD player, DVD player, cassette tape player or VCR). The original audio signals and secondary audio signals are mixed at the controlled volume levels, as selected using knobs 126 and 184a-184d, and output to a connected television, speakers or other audio playing device. The mixed audio signals may also be recorded on a select medium, using player/recorder component 160. Controls 168 are provided for operating the player/recorder component 160. Upon depressing the record button 169, the mixed audio signals are recorded, either alone or in combination with the original video signal, on the particular recording medium in the player/recorder component 160. The recorded audio signals, comprising the original audio signals and/or the secondary audio signals, can then be played back from the recorded medium for output to a connected auxiliary component, such as a television or speakers.

One or more remote control units 200 may be provided for controlling operation of any one or more of the system components of the device 120 including the player component 170 and the player/recorder component 160, as well as the volume controls 126 and 184a-184d.

In one preferred embodiment of the invention, a method of use of the device involves playing a type of game wherein at least one player, and preferably several players, take on a role of a character and/or background noise in an original program (e.g. movie or TV show) being played on the television. Each player is provided with a microphone and, when their character appears on the television, the player interjects their own choice of dialogue or sound effects which may be mixed with the character's original lines or dubbed-over to replace the original audio. The mixed or dubbed-over audio is recorded with the original video and played back for amusement.

While the instant invention has been shown and described in accordance with preferred and practical embodiments thereof, it is recognized that departures from the instant disclosure are contemplated with a spirit and scope of the present invention and are not intended to be limited except as set forth in the following claims as interpreted under the doctrine of equivalents.

1. An entertainment system comprising:
a first video input for receiving video signals from an original source;
a first audio input for receiving first audio signals from said original source;
a second audio input for receiving second audio signals from a secondary source independent of said original source;
a first volume control for selectively adjusting the volume level of said first audio signals;
a second volume control for selectively adjusting the volume level of said second audio signals; and
a device for mixing said selectively adjusted first audio signals with said selectively adjusted second audio signals.

2. The entertainment system as recited in claim 1 further comprising:
a recording device for recording said mixed first and second audio signals for subsequent playback.

3. The entertainment system as recited in claim 2 wherein said recording device is further structured and disposed for recording said video signals from said original source with said mixed first and second audio signals for subsequent playback.

4. The entertainment system as recited in claim 1 wherein said original source of said video signals and said first audio signals is a broadcast program.

5. The entertainment system as recited in claim 1 wherein said original source of said video signals and said first audio signals is a recorded medium.

6. The entertainment system as recited in claim 1 wherein said secondary source includes at least one microphone.

7. The entertainment system as recited in claim 6 wherein said second audio signals are transmitted through said one or more microphones and are derived from voice dialogue, noises and utterances made by one or more users.

8. An entertainment system comprising:
a first audio input for receiving first audio signals from said original source;
a second audio input for receiving second audio signals from a secondary source independent of said original source;
a first volume control for selectively adjusting the volume level of said first audio signals;
a second volume control for selectively adjusting the volume level of said second audio signals; and
a device for mixing said selectively adjusted first audio signals with said selectively adjusted second audio signals.

9. The entertainment system as recited in claim 8 further comprising:
a recording device for recording the mixed first and second audio signals for subsequent playback.

10. The entertainment system as recited in claim 9 wherein said original source of said first audio signals is a broadcast program.

11. The entertainment system as recited in claim 10 wherein the broadcast program is a conventional television signal.

12. The entertainment system as recited in claim 10 wherein said broadcast program is a cable television signal.

13. The entertainment system as recited in claim 10 wherein the broadcast program is a satellite television signal.

14. The entertainment system as recited in claim 9 wherein said original source is a recorded medium.

15. The entertainment system as recited in claim 9 wherein said secondary source includes at least one microphone and said second audio signals are derived from voice dialogue, noises and utterances made by one or more users through at least one microphone.

16. The entertainment system as recited in claim 15 wherein said secondary source comprises a plurality of said microphones.

17. A method of playing a game for amusement and entertainment, comprising the steps of:
providing a television monitor and speakers for playing an original program containing audio and video;
providing a device comprising:
a first video input for receiving video signals from the original program;
a first audio input for receiving first audio signals from the original program;
a second audio input for receiving second audio signals from a secondary source independent of the original program;
a first volume control for selectively adjusting the volume level of said first audio signals;
a second volume control for selectively adjusting the volume level of said second audio signals; and
means for mixing the selectively adjusted first audio signals with said selectively adjusted second audio signals;
providing a microphone to each of a plurality of players of the game;
playing the original program on the television monitor;
interjecting dialogue, utterances and noises by each of the plurality of players using the respective microphones;
adjusting the volume level of the audio of the original program;
adjusting the volume level of the interjected dialogue, noises and utterances of the players;
mixing the interjected dialogue, noises and utterances of the players with the audio of the original program;
recording the video of the original program with the mixed audio of the original program and interjected dialogue, noises and utterances of the players on a selected medium to produce a recorded master copy; and
playing the recorded master copy on the television monitor and speakers for amusement and entertainment.
